(19) United States
(12) Patent Application Publication
(10) Pub. No.: US 2012/0069368 A1
(43) Pub. Date: Mar. 22, 2012

(54) IMAGE FORMING APPARATUS, AND POWER-SAVING MODE SETTING METHOD OF THE IMAGE FORMING APPARATUS

(75) Inventor: Tohru WAGATSUMA, Shizuoka (JP)

(73) Assignees: Toshiba Tec Kabushiki Kaisha, Tokyo (JP); Kabushiki Kaisha Toshiba, Tokyo (JP)

(21) Appl. No.: 13/220,509

(22) Filed: Aug. 29, 2011

Related U.S. Application Data
(60) Provisional application No. 61/384,684, filed on Sep. 20, 2010.

(51) Int. Cl. G06F 3/12

(52) U.S. Cl. 358/1.13

(57) ABSTRACT

Certain embodiments provide an image forming apparatus including an image scanning unit, an image forming unit, a power source, a storage device, a setting section, and a control unit. The power source can supply power to the image scanning unit and the image forming unit. The storage device stores mode setting information including fixing unit offsetting information for setting a fixing unit off mode or fixing unit off cancellation information for cancelling the fixing unit off mode in which power supplied to the image forming unit is further lowered than power necessary when the image forming unit forms the reproduction image. The setting section causes the storage device to store the mode setting information. The control unit executes the fixing unit off mode based on the fixing unit off setting information stored in the storage device at least when power is supplied to the image scanning unit.

### CROSS REFERENCE TO RELATED APPLICATION

This application is based upon and claims the benefit of priority from Provisional U.S. Applications 61/384,684 filed on Sep. 20, 2010, the entire contents of which are incorporated herein by reference.

### FIELD

Embodiments described herein relate generally to a motor driving control device, an image forming apparatus, and a power-saving mode setting method of the image forming apparatus.

### BACKGROUND

A preheating mode and a sleep mode as a power-saving mode in an image forming apparatus of the related art are known. Each of a preheating mode button and a sleep mode button is formed on an operation panel, and a user presses one of the buttons to change to the preheating mode or to the sleep mode of the image forming apparatus.

In the power-saving mode of the related art, power consumption of the entire image forming apparatus is further lowered than that in the state where the image forming apparatus can print. Thus, when the power-saving mode is executed in the image forming apparatus of the related art, the power is not supplied to an image scanning unit which scans a document and an image forming unit including a fixing unit used for printing a reproduction image on a sheet. In the image forming apparatus of the related art, it is not possible to supply the power only to the image forming unit, nor is it possible to stop the power supply only to the image forming unit.

Thus, even when only scanning a document is necessary and printing a reproduction image of a document is not necessary, the user has to cancel the power-saving mode of the image forming apparatus, and the power supplied to the image forming unit in this case is wasted.

### BRIEF DESCRIPTION OF THE DRAWINGS

FIG. 1 is a block diagram showing an image forming apparatus according to an embodiment.

FIG. 2 is a top view schematically showing an operation panel provided in the apparatus.

FIG. 3 is a schematic cross-sectional view of the operation panel showing the relationship between a fixing unit off mode setting unit and an LED.

FIG. 4 is a flowchart showing a method of setting a power-saving mode (fixing unit off mode) when the fixing unit off mode setting unit is pressed during warm-up of the apparatus.

FIG. 5 is a flowchart showing the method when the fixing unit off mode setting unit is pressed when the apparatus is ready.

FIG. 6 is a flowchart showing the method when the fixing unit off mode setting unit is pressed during the formation of a reproduction image by the apparatus.

### DETAILED DESCRIPTION

An image forming apparatus according to an embodiment includes an image scanning unit, an image forming unit, a power source, a storage device, a fixing unit off mode setting unit, and a control unit. The image scanning unit scans an image on a document. The image forming unit forms a reproduction image of the image on the document on a sheet. The power source can supply power to the image scanning unit and the image forming unit. The storage device stores mode setting information which includes fixing unit off setting information for setting the fixing unit off mode in which the power supplied from the power source to the image forming unit is further lowered than power necessary for the image forming unit to form the reproduction image, or fixing unit off cancellation information for cancelling the fixing unit off mode. The fixing unit off mode setting unit causes the storage device to store the mode setting information. The control unit executes the fixing unit off mode based on the fixing unit off setting information stored in the storage device at least when power is supplied from the power source to the image scanning unit.

A power-saving mode setting method of the image forming apparatus according to an embodiment includes storing mode setting information in the storage device, determining whether or not the mode setting information is fixing unit off setting information, and executing the fixing unit off mode. The mode setting information includes fixing unit off setting information for setting the fixing unit off mode or fixing unit off cancelling information for cancelling the fixing unit off mode by operating the fixing unit off mode setting unit used for setting the fixing unit off mode in which the power supplied from the power source to the image forming unit that forms a reproduction image on a sheet based on image data scanned by the scanning unit that scans an image on a document is further lowered than power necessary during the formation of the reproduction image by the image forming unit. Determination of whether or not the mode setting information is the fixing unit off setting information depends on determination of whether or not the storage device stores the fixing unit off setting information. The fixing unit off mode is executed while at least power is supplied from the power source to the image scanning unit if, as a result of the determination, the storage device is determined to store the fixing unit off setting information.

Hereinafter, the image forming apparatus and a power-saving mode setting method of the image forming apparatus according to an embodiment will be described.

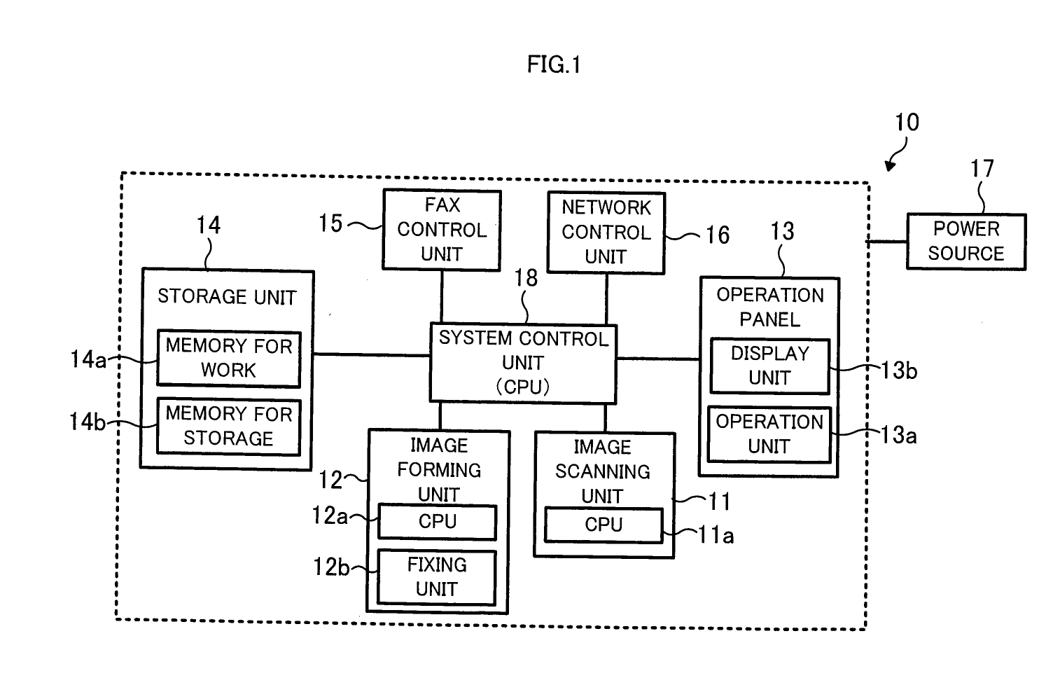

FIG. 1 is a block diagram showing the image forming apparatus according to an embodiment. The image forming apparatus 10 shown in FIG. 1 is an MFP (Multi-Function Peripheral or Multi-Function Printer) 10. The MFP 10 shown in FIG. 1 includes an image scanning unit 11, an image forming unit 12, an operation panel 13, a storage unit 14, a facsimile (hereinafter, referred to as a Fax) control unit 15, and a network control unit 16. In addition, the MFP 10 includes a power source 17 for supplying power to the above-described each unit.

The image scanning unit 11 includes a CPU 11a that controls the image scanning unit 11, and the image forming unit 12 includes a CPU 12a that controls the image forming unit 12. The CPUs 11a and 12a, the operation panel 13, the storage unit 14, the Fax control unit 15, and the network control unit 16 are controlled by a system control unit 18 that is another CPU. The system control unit 18 controls each of the units with a control program stored in the storage unit 14. In addition, the system control unit 18 is a control unit for executing the fixing unit off mode to be described later.

The image scanning unit 11 scans images on a document, and forms image data based on the scanned images. The image scanning unit 11 includes a document table that supports documents (not shown in the drawing), an exposure device that exposes documents (not shown in the drawing), an image sensor that forms image data (not shown in the drawing), and an automatic document feeder (ADF) that guides documents at a predetermined position on the document table (not shown in the drawing), and the like.

The image forming unit 12 forms on a sheet a reproduction image of an image on a document based on image data. The image forming unit 12 includes a photoreceptor drum that retains latent images (not shown in the drawing), an exposure device that forms latent images on the photoreceptor drum (not shown in the drawing), a developing device that develops by supplying toner to latent images retained on the photoreceptor drum (not shown in the drawing), a transfer belt that transfers toner images retained on the photoreceptor drum in order (not shown in the drawing), a transfer device that transfers toner images retained by the transfer belt onto a sheet (not shown in the drawing), a fixing device that fixes a reproduction image of a document formed on a sheet onto the sheet by transferring toner images on the sheet by the transfer device (not shown in the drawing), and the like.

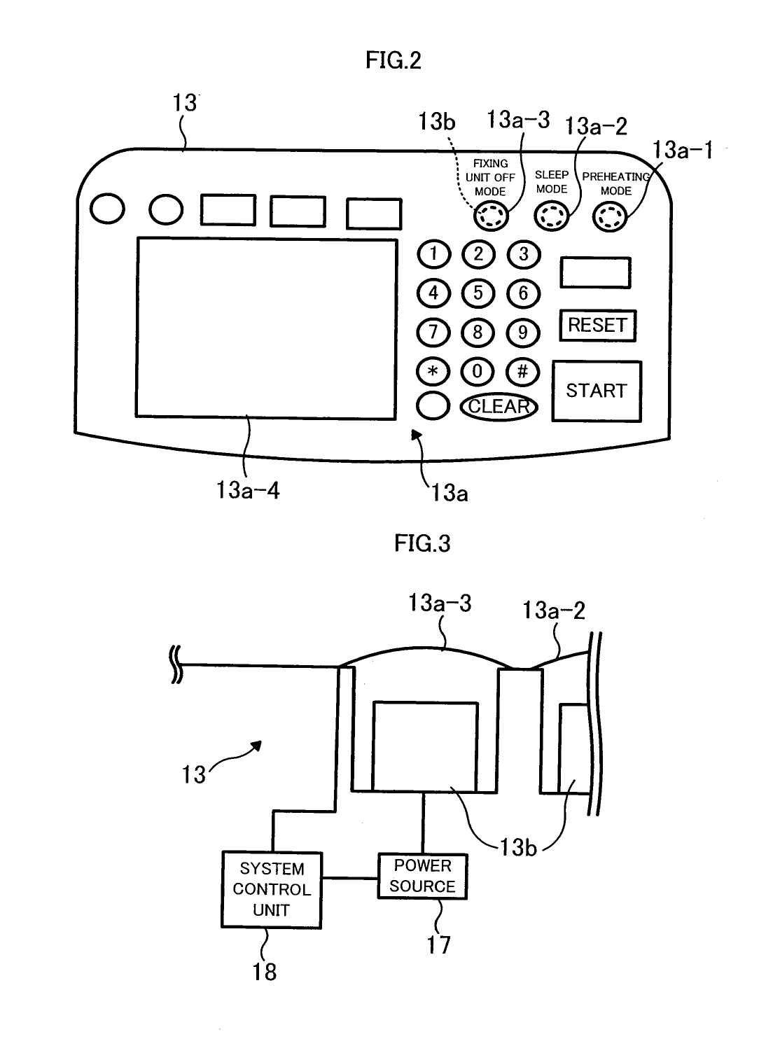

FIG. 2 is a top view schematically showing the operation panel 13. As shown in FIG. 2, the operation panel 13 includes an operation unit 13a that gives various instructions to the MFP 10 such as an instruction of starting scanning of images on a document by the image scanning unit 11, an instruction of starting image formation to the image forming unit 12, and the like.

The operation unit 13a of the operation panel 13 includes a preheating mode setting section 13a-1 for setting the MFP 10 to a preheating mode, a sleep mode setting section 13a-2 for setting the MFP 10 to a sleep mode, and a fixing unit off mode setting section 13a-3 for setting the MFP 10 to a fixing unit off mode. These setting sections 13a-1, 13a-2, and 13a-3 are buttons that can be pressed down as shown, for example, FIG. 2.

Furthermore, the operation unit 13a of the operation panel 13 includes a liquid crystal panel 13a-4.

The preheating mode is a mode in which power consumption by the MFP 10 is reduced by making the amount of power to be supplied to the image scanning unit 11 and the operation panel 13 substantially zero and reducing the power to be supplied to a fixing unit 12b of the image forming unit 12. When a user presses down the preheating mode setting section 13a-1, the power is not supplied to the image scanning unit 11 and the operation panel 13, and therefore, an image on a document cannot be scanned, and various instructions cannot be given to the MFP 10 by the operation unit 13a. In addition, when the preheating mode setting section 13a-1 is pressed down, the power supplied to the fixing unit 12b of the image forming unit 12 is reduced, and accordingly, the temperature of the fixing unit 12b is further lowered than the temperature that enables fixing of a reproduction image to a sheet, and therefore, the reproduction image cannot be fixed to the sheet.

The sleep mode is a mode in which power consumption by the MFP 10 is reduced by making the amount of power supplied to each unit of the MFP 10 except for the operation panel 13 substantially zero, without reducing the power supplied to the operation panel 13. When the user presses down the sleep mode setting section 13a-2, the power is not supplied to the image scanning unit 11 and the image forming unit 12, and therefore, an image on a document cannot be scanned, and a reproduction image also cannot be formed on a sheet.

The fixing unit off mode is a mode in which power consumption by the MFP 10 is reduced by making the amount of power supplied only to the fixing unit 12b of the image forming unit 12 substantially zero, without reducing the power supplied to the operation panel 13 and the image scanning unit 11. When a user presses down the fixing unit off mode setting section 13a-3 to set the fixing unit off mode, power is not supplied to the fixing unit 12b, and accordingly, a reproduction image cannot be formed on a sheet. However, since power is supplied to the operation panel 13 and the image scanning unit 11, scanning an image on a document and giving various instructions from the operation unit 13a to the MFP 10 are possible.

The fixing unit off mode is effective when the image scanning unit 11 needs to scan an image on a document and the image forming unit 12 does not need to form a reproduction image.

The fixing unit off mode is better to reduce power consumption by the MFP 10 when it is necessary to scan an image on a document and not necessary to form a reproduction image. Therefore, the fixing unit off mode may be a mode in which power consumption by the MFP 10 is reduced by lowering power supplied to the fixing unit 12b than power necessary for the fixing unit 12b to fix a reproduction image on a sheet.

Furthermore, the preheating mode setting section 13a-1 the sleep mode setting section 13a-2 and the fixing unit off mode setting section 13a-3 may not be buttons as shown in FIG. 2, but may be a form displayed on the liquid crystal panel 13a-4 of the operation unit 13a.

In addition, the operation panel 13 includes a display unit 13b. The display unit 13b displays whether or not the fixing unit off mode is set for a user. The display unit 13b is, for example, an LED 13b. When the display unit 13b is the LED 13b, the LED 13b displays whether or not the fixing unit off mode is set, as follows. In other words, the LED 13b displays whether or not the fixing unit off mode is set by turning on the LED 13b when the fixing unit off mode is set, and by turning off the LED 13b when the fixing unit off mode is not set.

The LED 13b may be provided at any position on the operation panel 13. The LED 13b is buried right below the fixing unit off mode setting section 13a-3 as shown in, for example, FIG. 3. Accordingly, if the LED 13b is turned on when the fixing unit off mode is set, the fixing unit off mode setting section 13a-3 is turned on. In addition, if the LED 13b is turned off when the fixing unit off mode is not set, the fixing unit off mode setting section 13a-3 is turned off.

The display unit 13b may display whether or not the fixing unit off mode is set to the user. Thus, the liquid crystal panel 13a-4 of the operation unit 13a may also serve as the display unit 13b. When the display unit 13b is the liquid crystal panel 13a-4, the liquid crystal panel 13a-4 may display a message indicating whether or not the fixing unit off mode is set.

Furthermore, it is preferable that the display indicating that the fixing unit off mode is set be performed at the same time when the fixing unit off mode setting section 13a-3 is pressed down. The reason will be described later, but if the display indicating that the fixing unit off mode is set is performed at the same time when the fixing unit off mode setting section 13a-3 is pressed down, it is possible to prevent distrust in product that the user may harbor in regard to the MFP 10.

The storage unit 14 is a non-volatile memory that maintains storage even when the power from the power source 17 is not supplied, and has a first storage unit that is a memory for work 14a and a second storage unit that is a memory for storage 14b. The above-described control program is stored in the memory for work 14a. The memory for storage 14b stores mode setting information that is information for setting the fixing unit off mode (fixing unit off setting information) or information for cancelling the fixing unit off mode (fixing unit off cancellation information), and image data formed by the image scanning unit 11.

Furthermore, the mode setting information is automatically rewritten and stored in the memory for storage 14b every time the fixing unit off mode setting section 13a-3 is pressed down. If the fixing unit off mode setting section 13a-3 is pressed down in the state that the fixing unit off setting information is stored, the mode setting information is rewritten to the fixing unit off cancellation information. On the contrary, if the fixing unit off mode setting section 13a-3 is pressed down in the state that the fixing unit off cancellation information is stored, the mode setting information is rewritten to the fixing unit off setting information. In other words, the fixing unit off mode setting section 13a-3 is a section for causing the memory for storage 14b to store the fixing unit off setting information or the fixing unit off cancellation information.

The Fax control unit 15 controls the facsimile function of the MFP 10. In addition, the network control unit 16 controls the connection state between the MFP 10 and a network such as the Internet.

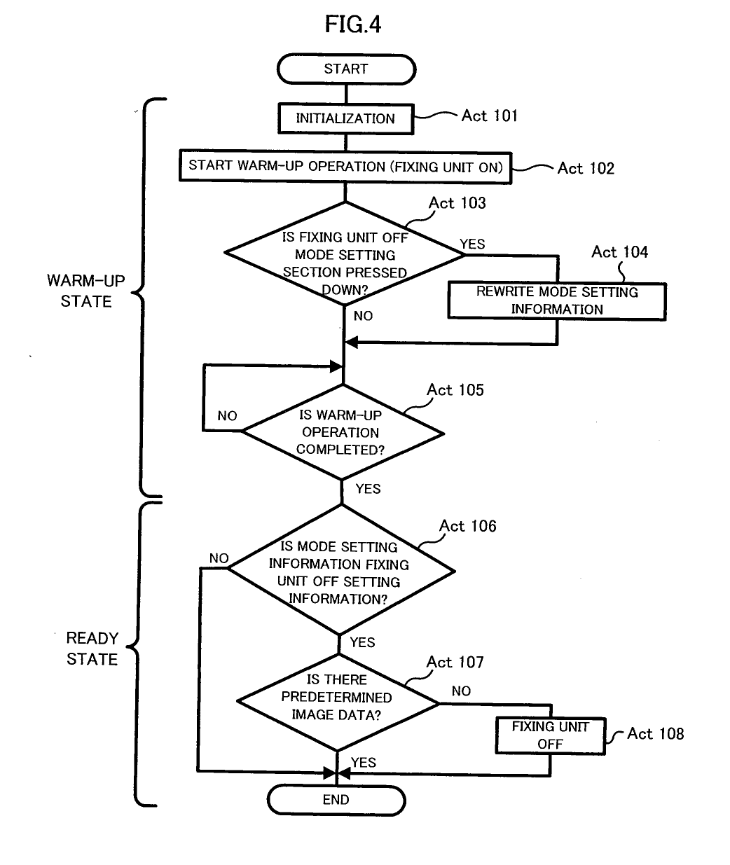

Next, a power-saving mode setting method of the image forming apparatus according to the embodiment will be described. Furthermore, the MFP 10 described above includes the preheating mode, sleep mode, and fixing unit off mode, as the power-saving mode, however, the preheating mode and the sleep mode are generally known, and thus, description thereof will be omitted, and hereinbelow, a fixing unit off mode setting method as a power-saving mode setting method will be described referring to FIGS. 4, 5, and 6.

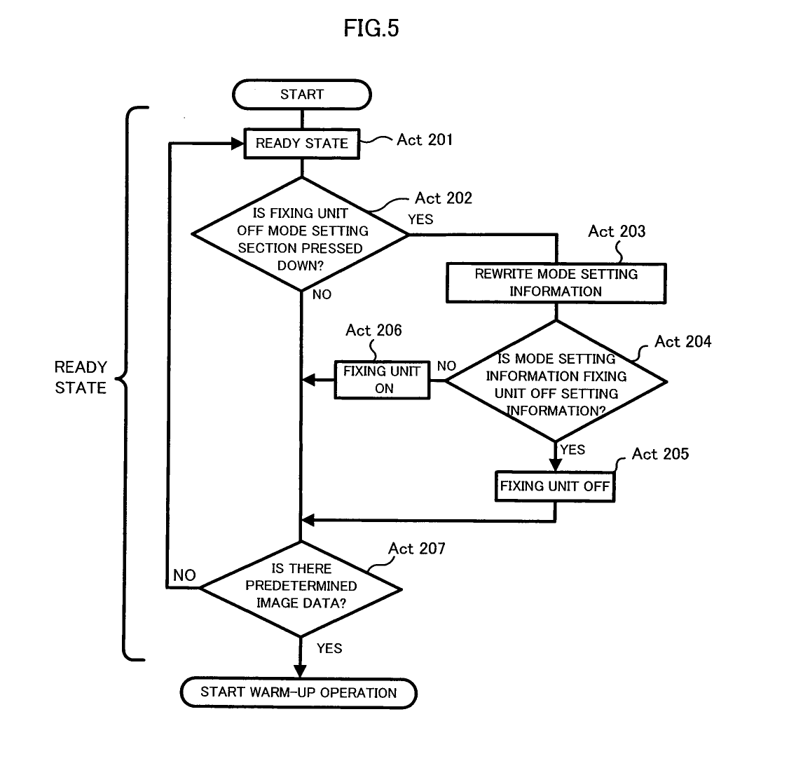

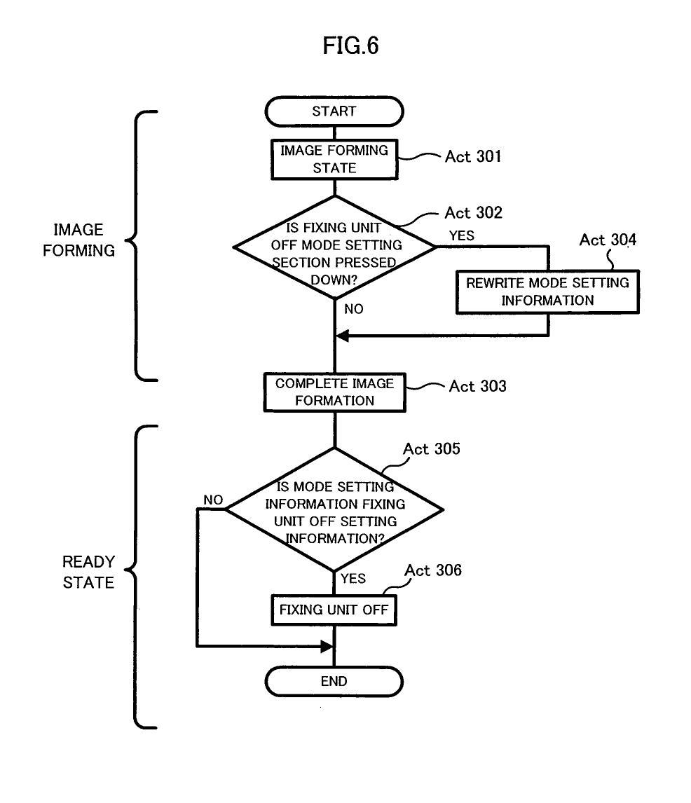

FIG. 4 is a flowchart showing a power-saving mode (fixing unit off mode) setting method when the fixing unit off mode setting section 13a-3 is pressed down during the warm-up of the MFP 10, FIG. 5 is a flowchart showing another power-saving mode (fixing unit off mode) setting method when the fixing unit off mode setting section 13a-3 is pressed down while the MFP 10 is ready, and FIG. 6 is a flowchart showing another power-saving mode (fixing unit off mode) setting method when the fixing unit off mode setting section 13a-3 is pressed down while the MFP 10 forms a reproduction image. Furthermore, a series of operations shown below is executed by the system control unit 18 according to the control program stored in the memory for work 14a.

First of all, referring to FIG. 4, a fixing unit off mode setting method when the fixing unit off mode setting section 13a-3 is pressed down during the warm-up of the MFP 10 will be described.

First, after the MFP 10 is initialized (Act 101), the MFP 10 starts the warm-up operation (Act 102). The warm-up operation means an operation for turning the MFP 10 into a state where input of an image on a document and formation of a reproduction image are possible. Accordingly, when the warm-up operation starts, the system control unit 18 supplies power from the power source 17 to the image scanning unit 11, and the image forming unit 12 including the fixing unit 12b.

If the fixing unit off mode setting section 13a-3 is pressed down from the time when the MFP 10 starts the warm-up operation to the time when the warm-up operation is completed, the system control unit 18 determines whether or not the fixing unit off mode setting section 13a-3 is pressed down (Act 103). Furthermore, it is preferable that the system control unit 18 display that the fixing unit off mode is set or the fixing unit off mode is cancelled (for example, the LED 13b is turned on or off) on the display unit 13b of the operation panel 13 at the same time when the signal indicating that the fixing unit off mode setting section 13a-3 is pressed down is received.

As a result of determination in Act 103, when it is determined that the fixing unit off mode setting section 13a-3 is not pressed down (NO in Act 103), the system control unit 18 does not rewrite mode setting information stored in the memory for storage 14b.

On the contrary, when it is determined that the fixing unit off mode setting section 13a-3 is pressed down as a result of determination in Act 103 (YES in Act 103), the system control unit 18 rewrites mode setting information stored in the memory for storage 14b (Act 104).

In Act 104, when the mode setting information stored in the memory for storage 14b before the fixing unit off mode setting section 13a-3 is pressed down is fixing unit off setting information, the system control unit 18 rewrites the mode setting information to fixing unit off cancellation information. On the contrary, when the mode setting information stored in the memory for storage 14b before the fixing unit off mode setting section 13a-3 is pressed down is fixing unit off cancellation information, the system control unit 18 rewrites the mode setting information to fixing unit off setting information.

After it is determined that the fixing unit off mode setting section 13a-3 is not pressed down in Act 103, or the mode setting information is rewritten in Act 104, the system control unit 18 checks whether or not the warm-up operation is completed (Act 105). This checking determines, for example, whether or not the fixing unit 12b reaches a predetermined temperature. If the fixing unit 12b reaches the predetermined temperature, it is determined that the warm-up operation is completed, and if the fixing unit 12b does not reach the predetermined temperature, it is determined that the warm-up operation is not completed.

If the warm-up operation is completed (YES in Act 105), the MFP 10 completes the warm-up operation, and the MFP 10 transfers to a ready-state. If the warm-up operation is not completed (NO in Act 105), the MFP 10 continues the warm-up operation until it is determined that the warm-up operation is completed in Act 105.

As such, when the fixing unit off mode setting section 13a-3 is pressed down during the warm-up operation of the MFP 10, the mode setting information is rewritten, but the fixing unit off mode is not executed. Accordingly, supply of power to the fixing unit 12b is continued until the warm-up operation is completed.

If the MFP 10 is in the ready state, the system control unit 18 determines whether or not the mode setting information is the fixing unit off setting information referring to the memory for storage 14b (Act 106).

In Act 106, when it is determined that the mode setting information is not the fixing unit off setting information (NO in Act 106), that is, the mode setting information is the fixing unit off cancellation information, the system control unit 18 causes the MFP 10 to maintain the general ready state. Furthermore, the general ready state means a ready state where the fixing unit off mode is not executed (power is supplied to the fixing unit 12b).

In Act 106, when it is determined that the mode setting information is the fixing unit off setting information (YES in Act 106), the system control unit 18 determines whether or not desired image data is stored in the memory for storage 14b referring to the memory for storage 14b (Act 107). Furthermore, the image data may be image data read in the MFP 10 after the completion of warm-up (after Act 105), or may be image data read during the period when an image on a document can be read before that time. In addition, the desired image data is image data designated by, for example, user operation of the operation unit 13a of the operation panel 13.

In Act 107, when it is determined that the desired image data is stored in the memory for storage 14b (YES in Act 107), it is determined that there is a possibility that the image forming unit 12 forms a reproduction image based on the image data, and the system control unit 18 causes the MFP 10 to maintain the general ready state.

When it is determined that the desired image data is not stored in the memory for storage 14b in Act 107 (NO in Act 107), it is determined that there is no possibility that the image forming unit 12 forms a reproduction image, and the system control unit 18 stops the power supply to the fixing unit 12b (Act 108). If power is not supplied to the fixing unit 12b, the temperature of the fixing unit 12b drops.

As such, if the fixing unit off mode setting section 13a-3 is pressed down during the warm-up, only the mode setting information is rewritten when the fixing unit off mode setting section 13a-3 is pressed down, and the information is stored. Then, when the system control unit 18 determines that there is no need to form a reproduction image after the MFP 10 transfers to the ready state (NO in Act 107), fixing unit off mode setting is executed.

Next, a power-saving mode (fixing unit off mode) setting method when the fixing unit off mode setting section 13a-3 is pressed down when the MFP 10 is in the general ready state or in the ready state where the fixing unit off mode is set will be described referring to FIG. 5.

If the fixing unit off mode setting section 13a-3 is to be pressed down when the MFP 10 is in the ready state (Act 201), the system control unit 18 determines whether or not the fixing unit off mode setting section 13a-3 is pressed down (Act 202). Furthermore, it is preferable that the system control unit 18 cause the display unit 13b of the operation panel 13 to display that the fixing unit off mode is set or the fixing unit off mode is cancelled (for example, the LED 13b is turned on or off) at the same time when the signal indicating that the fixing unit off mode setting section 13a-3 is pressed down is received.

When it is determined that the fixing unit off mode setting section 13a-3 is not pressed down as a result of determination in Act 202 (NO in Act 202), the system control unit 18 does not rewrite the mode setting information stored in the memory for storage 14b.

On the contrary, when it is determined that the fixing unit off mode setting section 13a-3 is pressed down as a result of determination in Act 202 (YES in Act 202), the system control unit 18 rewrites the mode setting information stored in the memory for storage 14b (Act 203).

After the mode setting information is rewritten in Act 203, the system control unit 18 determines whether or not the mode setting information is the fixing unit off setting information referring to the memory for storage 14b (Act 204).

When it is determined that the mode setting information is the fixing unit off setting information in Act 204 (YES in Act 204), the system control unit 18 stops the power supply to the fixing unit 12b (Act 205), and the MFP 10 is in the ready state where the fixing unit off mode is set.

When it is determined that the mode setting information is not the fixing unit off setting information in Act 204 (NO in Act 204), the system control unit 18 supplies power to the fixing unit 12b (Act 206), and the MFP 10 is in the general ready state.

After the MFP 10 is made to be in the ready state where the fixing unit off mode is set in Act 205, or the MFP 10 is made to be in the general ready state in Act 206, the system control unit 18 determines whether or not the desired image data is stored in the memory for storage 14b referring to the memory for storage 14b (Act 207). When it is determined that the desired image data is stored in the memory for storage 14b in Act 207 (YES in Act 207), the system control unit 18 causes the MFP 10 to start the warm-up operation. On the contrary, when it is determined that the desired image data is not stored in the memory for storage 14b in Act 207 (NO in Act 207), the MFP 10 maintains the ready state.

As such, if the fixing unit off mode setting section 13a-3 is to be pressed down when the MFP 10 is in the ready state, the mode setting information is rewritten when the fixing unit off mode setting section 13a-3 is pressed down, immediately after that, the fixing unit off mode is set or cancelled based on the rewritten mode setting information.

Next, a power-saving mode (fixing unit off mode) setting method when the fixing unit off mode setting section 13a-3 is pressed down during the formation of a reproduction image by the MFP 10 will be described referring to FIG. 6.

If the fixing unit off mode setting section 13a-3 is to be pressed down when the MFP 10 forms a reproduction image (Act 301), the system control unit 18 determines whether or not the fixing unit off mode setting section 13a-3 is pressed down (Act 302). Furthermore, it is preferable that the system control unit 18 cause the display unit 13b of the operation panel 13 to display that the fixing unit off mode is set or the fixing unit off mode is cancelled (for example, the LED 13b is turned on or off) at the same time when the signal indicating that the fixing unit off mode setting section 13a-3 is pressed down is received.

When it is determined that the fixing unit off mode setting section 13a-3 is not pressed down as a result of determination in Act 302 (NO in Act 302), the system control unit 18 waits the completion of reproduction image formation based on the desired image data stored in the memory for storage 14b to complete the image formation (Act 303), without rewriting the mode setting information stored in the memory for storage 14b.

On the contrary, when it is determined that the fixing unit off mode setting section 13a-3 is pressed down as a result of determination in Act 302 (YES in Act 302), the system control unit 18 rewrites the mode setting information stored in the memory for storage 14b (Act 304).

After the mode setting information is rewritten in Act 304, the system control unit 18 awaits the completion of reproduction image formation based on the desired image data stored in the memory for storage 14b to complete the image formation (Act 303).

If the image formation is completed in Act 303, the MFP 10 transfers to the general ready state. In this state, the system control unit 18 determines whether or not the mode setting information is fixing unit off setting information referring to the memory for storage 14b (Act 305).

When it is determined that the mode setting information is not the fixing unit off setting information in Act 305 (NO in Act 305), the system control unit 18 causes the MFP 10 to maintain the general ready state.

When it is determined that the mode setting information is the fixing unit off setting information in Act 305 (YES in Act 305), the system control unit 18 stops the power supply to the fixing unit 12b (Act 306), and causes the MFP 10 to be in the ready state where the fixing unit off mode is set.

As such, if the fixing unit off mode setting section 13a-3 is pressed down during the image formation, only the mode setting information is rewritten when the fixing unit off mode setting section 13a-3 is pressed down, and the information is stored. Then, when the mode setting information is determined to be the fixing unit off setting information (YES in Act 305), the system control unit 18 executes the fixing unit off mode setting after the MFP 10 transfers to the ready state.

As described above, according to the image forming apparatus, and the power-saving mode setting method of the image forming apparatus of the embodiment, supply of power only to the fixing unit 12b can be stopped. Accordingly, power consumed by the image forming apparatus when only scanning of a document is needed but printing of a reproduction image on the document is not needed is reduced more than in the image forming apparatus of the related art.

In addition, according to the image forming apparatus, and the power-saving mode setting method of the image forming apparatus of the embodiment, it is possible to display for a user whether or not the fixing unit off mode is set at the same time when the fixing unit off mode setting section 13a-3 is pressed down. Accordingly, it is possible to prevent distrust in a product that a user may harbor.

Hereinbelow, the prevention of distrust in product will be described. Particularly, it is considered that a user presses down the fixing unit off mode setting section 13a-3 when the MFP 10 is in the ready state. When the MFP 10 before the pressing-down is in the ready state where the fixing unit off mode is set, the MFP 10 transfers to the general ready state by pressing down the fixing unit off mode setting section 13a-3. The transfer time is the time taken until, for example, the fixing unit 12b reaches a predetermined temperature. During this time, the user has to await scanning of an image on a document and the formation of a reproduction image even though the MFP is in the ready state. If whether or not the fixing unit off mode is set is not displayed to the user, the user does not understand why he or she has to wait for the time taken until the MFP 10 transfers to the general ready state. Therefore, the waiting time arouses distrust in the product for the user.

However, if whether or not the fixing unit off mode is set is displayed to the user, the user can understand the reason for waiting for the time taken until the MFP 10 transfers to the generally ready state. Therefore, despite the waiting time, it is possible to prevent distrust in the product that the user may harbor.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image forming apparatus comprising:
an image scanning unit which scans an image on a document;
an image forming unit which forms a reproduction image of the image on the document on a sheet;
a power source which can supply power to the image scanning unit and the image forming unit;
a storage device which stores mode setting information including fixing unit off setting information for setting fixing unit off mode or fixing unit off cancellation information for cancelling the fixing unit off mode in which power supplied from the power source to the image forming unit is further lowered than power necessary for the image forming unit to form the reproduction image;
a fixing unit off mode setting section for storing the mode setting information in the storage device; and
a control unit which executes the fixing unit off mode based on the fixing unit off setting information stored in the storage device at least when power is supplied from the power source to the image scanning unit.

2. The apparatus according to claim 1, wherein the fixing unit off mode is a mode in which power is not supplied from the power source to the image forming unit.

3. The apparatus according to claim 1, wherein
the image forming unit has a fixing unit for fixing the reproduction image onto the sheet, and
the fixing unit off mode is a mode in which power supplied from the power source to the fixing unit is further lowered than power necessary when the fixing unit fixes the reproduction image onto the sheet.

4. The apparatus according to claim 3, wherein the fixing unit off mode is a mode where power is not supplied from the power source to the fixing unit.

5. The apparatus according to claim 1, further comprising:
an operation panel used for giving a predetermined instruction thereto,
wherein the fixing unit off mode setting section is provided in the operation panel.

6. The apparatus according to claim 5, wherein the fixing unit off mode setting section is a button that can be pressed down.

7. The apparatus according to claim 1, further comprising:
a display unit which displays the mode setting information stored in the storage device at the same time when the fixing unit off mode setting section is operated.

8. The apparatus according to claim 7, further comprising:
an operation panel which gives a predetermined instruction thereto,
wherein the display unit is provided in the operation panel.

9. The apparatus according to claim 8, wherein
the display unit is an LED, and
the mode setting information is displayed by turning the LED on or off.

10. The apparatus according to claim 8, wherein
the operation panel includes a liquid crystal display unit, and
the display unit is the liquid crystal display unit.

11. A power-saving mode setting method of an image forming apparatus, comprising:
storing mode setting information including fixing unit off setting information for setting a fixing unit off mode or fixing unit off cancellation information for cancelling the fixing unit off mode in a storage device by operating a fixing unit off mode setting section for setting the fixing unit off mode in which power supplied from a power source to an image forming unit which forms a reproduction image on a sheet based on image data scanned by an image scanning unit that scans an image on a document is further lowered than power necessary when the image forming unit forms the reproduction unit;
determining whether or not the storage device stores the fixing unit off setting information; and
executing the fixing unit off mode at least when power is supplied from the power source to the image scanning unit if it is determined that the storage device stores the fixing unit offsetting information as a result of the determination.

12. The method according to claim 11, wherein the fixing unit off mode is a mode where power from the power source is not supplied to the image forming unit.

13. The method according to claim 11, wherein
the image forming unit includes a fixing unit for fixing the reproduction image onto the sheet, and
the fixing unit off mode is a mode in which power supplied from the power source to the fixing unit is further lowered than power necessary when the fixing unit fixes the reproduction image onto the sheet.

14. The method according to claim 13, wherein the fixing unit off mode is a mode where power is not supplied from the power source to the fixing unit.

15. The method according to claim 11, wherein the fixing unit off mode setting section is provided in an operation panel used for giving a predetermined instruction to the image forming apparatus.

16. The method according to claim 15, wherein the fixing unit off mode setting section is a button that can be pressed down.

17. The method according to claim 11, wherein the mode setting information stored in the storage device is displayed at the same time when the fixing unit off mode setting section is operated.

18. The method according to claim 17, wherein the mode setting information is displayed on the operation panel used for giving a predetermined instruction to the image forming apparatus.

19. The method according to claim 18, wherein the mode setting information is displayed by turning the LED provided on the operation panel on or off.

20. The method according to claim 18, wherein the mode setting information is displayed on a liquid crystal display unit provided on the operation panel.
